(19) United States
(12) Patent Application Publication
(10) Pub. No.: US 2022/0207496 A1
(43) Pub. Date: Jun. 30, 2022

(54) WASTEWATER METERING DEVICES AND METHODS

(71) Applicant: Verified Haul, LLC, Minot, ND (US)

(72) Inventors: Barrett WITHERS, Minot, ND (US); Mark UVODICH, Overland Park, KS (US)

(21) Appl. No.: 17/139,017

(22) Filed: Dec. 31, 2020

(51) Int. Cl. G06Q 10/00; G06Q 30/02; G06Q 20/08

(52) U.S. Cl. CPC G06Q 10/30; G06Q 20/085; G06Q 30/0283

(57) ABSTRACT

A wastewater metering system includes a driver device, a meter device, and a server. The driver device is associated with a disposal vehicle and is configured to acquire a set of driver information. The meter device is associated with a disposal location and is configured to acquire a set of meter information. The server is communicatively coupled with at least one of the driver device and the meter device. The server includes a processor configured to: acquire the set of driver information and the set of meter information; generate an electronic ticket based at least in part of the set of driver information and the set of meter information; and provide the electronic ticket via an electronic resource.

### FIELD OF THE INVENTION

The present disclosure generally relates to the removal of wastewater from various extraction sites such as oil wells, and more specifically to metering devices and methods for measuring and reporting the wastewater.

### BACKGROUND

Water is used in the production of oil and gas. Refineries can generate a significant amount of wastewater that has been in contact with hydrocarbons or other contaminants. In a typical refinery, two and a half gallons of water may be used for the generation of a single gallon of oil. Wastewater can also include water rejected from boiler feedwater pretreatment processes (or generated during regenerations). Wastewater can also refer to water removed from the product, water used in cooling tower blowdown stream water, or water used in cooling water that leaves the refinery.

Wastewater is typically discharged to a water truck which transports the wastewater to a discharge location. The discharge location may process or otherwise dispose of the wastewater. The production facilities pay for transportation of their wastewater to the discharge location and the discharge thereof. However, currently these production facilities rely on the water truck to relay the amount of water delivered. This incentivizes the driver to over-estimate the amount of wastewater reported, without any way for the production company to verify an amount of wastewater actually delivered.

This background discussion is intended to provide information related to the present invention which is not necessarily prior art.

### BRIEF SUMMARY

Embodiments of the invention solve the above-mentioned problem (as well as other problems) by providing a wastewater metering system which utilizes a meter at a disposal location, which is associated with a meter device. The meter device gathers information about the delivery, including a delivery amount, and reports this information to a server. The server performs any of various functions with the collected data, such as production of an electronic ticket, facilitation of payment, record keeping, etc.

A first embodiment of the invention is broadly directed to a wastewater metering system comprising a driver device, a meter device, and a server. The driver device is associated with a disposal vehicle and is configured to acquire a set of driver information. The meter device is associated with a disposal location and is configured to acquire a set of meter information. The server is communicatively coupled with at least one of the driver device and the meter device. The server includes a processor configured to: acquire the set of driver information and the set of meter information; generate an electronic ticket based at least in part of the set of driver information and the set of meter information; and provide the electronic ticket via an electronic resource.

A second embodiment of the invention is broadly directed to a computerized method of metering wastewater comprising: acquiring a set of meter information associated with a disposal location for wastewater; acquiring a set of driver information associated with a disposal vehicle for wastewater; analyzing the set of driver information and the set of meter information; generating an electronic ticket based at least in part of the set of driver information and the set of meter information; and providing the electronic ticket via an electronic resource.

A third embodiment of the invention is broadly directed to a non-transitory computer readable storage medium having a computer program stored thereon, wherein the computer program, when executed by at least one processing elements, instructs the at least one processing element to perform steps comprising: acquiring a set of meter information associated with a disposal location for wastewater; acquiring a set of driver information associated with a disposal vehicle for wastewater; analyzing the set of driver information and the set of meter information; generating an electronic ticket based at least in part of the set of driver information and the set of meter information; and providing the electronic ticket via an electron is resource.

Other embodiments of the invention may be broadly directed to a driver device. Still other embodiments of the invention may be directed to a meter device. Yet other embodiments of the invention may be directed to a wastewater metering system comprising a metering device and a driver device. Yet still other embodiments of the invention may be directed to a method of controlling a metering device and/or a driver device.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 is an exemplary environmental view showing usage of a wastewater metering system;

FIG. 2 is a diagram showing exemplary data which may be collected by the wastewater metering system;

FIG. 3 is a diagram showing exemplary hardware components of the wastewater metering system; and

FIG. 4 is a diagram showing exemplary steps performed by the wastewater metering system.

The Figures depict exemplary embodiments for purposes of illustration only. One skilled in the art will readily recognize from the following discussion that alternative embodiments of the systems and methods illustrated herein may be employed without departing from the principles of the invention described herein. While the drawings do not necessarily provide exact dimensions or tolerances for the illustrated components or structures, the drawings, not including any purely schematic drawings, are to scale with respect to the relationships between the components of the structures illustrated therein.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments. For instance, the drawing figures do not limit the present invention to the specific embodiments disclosed and described herein. Furthermore, directional references (for example, top, bottom, up, and down) are used herein solely for the sake of convenience and should be understood only in relation to each other. For instance, a component might in practice be oriented such that faces referred to as “top” and “bottom” are sideways, angled or inverted relative to the chosen frame of reference.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the present technology can include a variety of combinations and/or integrations of the embodiments described herein.

Exemplary Environment and Usages

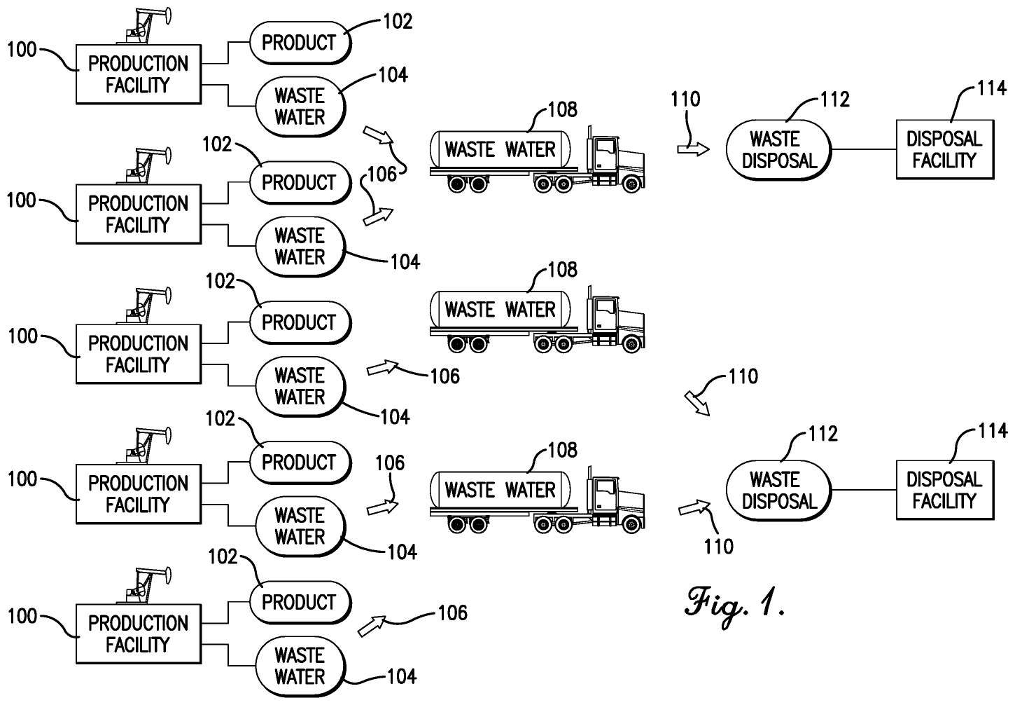

Embodiments of the invention may be utilized in any of various environments. An exemplary environment is shown in FIG. 1 and discussed below. However, it should be appreciated that this environment is only exemplary and that various embodiments of the invention may be utilized in other environments.

Turning to FIG. 1, an exemplary environment for embodiments of the invention is shown. In this exemplary environment, there may be one or more production facilities 100. The production facility 100 may include, or otherwise be associated with, a product tank 102 and a wastewater tank 104. The wastewater in the wastewater tank requires disposal.

In the exemplary environment, oil and gas (generically, “product”) is being produced at numerous production facilities 100 spread over a geographic area (shown on the left side of FIG. 1 for simplicity). Each production facility 100 includes various production equipment for extracting, processing, and storage. The production facilities 100 may utilize a broad array of techniques and equipment. Each production facility 100 includes a product tank 102 and a wastewater tank 104. The product tank 102 stores the product until it is transported via vehicle, pipeline, or other transportation structure.

The wastewater tank 104 is located at or near the production facility 100. The wastewater tank 104 is configured to hold wastewater from the production process. The wastewater may be produced in any of the various methods described above, such as being used in the machinery or being removed from the product. The wastewater may be capable of filtration or may be beyond filtration such that it can only be disposed. In the exemplary environment, and as discussed below, the wastewater is picked up and transported for disposal.

The wastewater tank 104 may include one or more pickup apparatus 106. The pickup apparatus 106 is configured to transfer wastewater to a transportation vehicle 108. The pickup apparatus 106 may include a valve, a nozzle, or other structure configured to transfer the wastewater. The pickup apparatus 106 may also include a meter, not illustrated, to measure the amount of wastewater transferred to the transportation vehicle 108. However, meters on the wastewater tank 104 are not common in the industry. Thus, embodiments of the invention provide fidelity to the production facilities 100 on how much wastewater was transported (as discussed in depth below), without requiring each production facility 100 to provide and monitor a meter.

The transportation vehicle 108 receives the wastewater from the pickup apparatus 106. The transportation vehicle 108 then travels to deliver the wastewater to a drop off apparatus 110 associated with a wastewater receiving tank 112 at a disposal facility 114. In some instances, the disposal facility 114 may filter or otherwise rehabilitate the wastewater. In other instances, the disposal facility 114 may alternatively dispose of the wastewater, such as into an underground reservoir. The wastewater may be stored in the wastewater receiving tank 112 until disposal.

A second exemplary environment may be the disposal of other items. For example, large scale garbage removal from a single site may utilize embodiments of the invention in metering and tracking transportation to disposal facilities. Large scale items that may be measured by weight or volume could utilize one of the below discussed meters to measure the amount transported and disposed.

A third exemplary environment may be transportation of other items. For example, delivery companies may utilize a similar system for transportation of items to a certain destination.

It should be appreciated that while the portions of the description herein relate to the oil and gas production wastewater disposal exemplary purpose, various embodiments may be directed to other or multiple purposes. The oil and gas production wastewater disposal purpose is discussed to provide an understandable example to the reader.

Exemplary Wastewater Disposal System

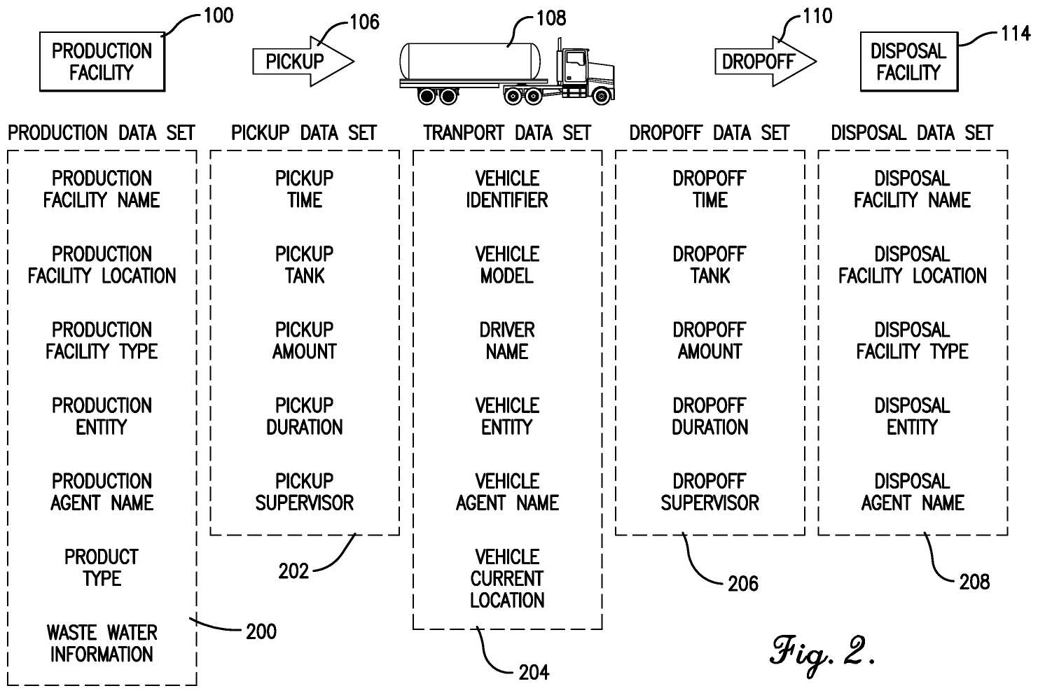

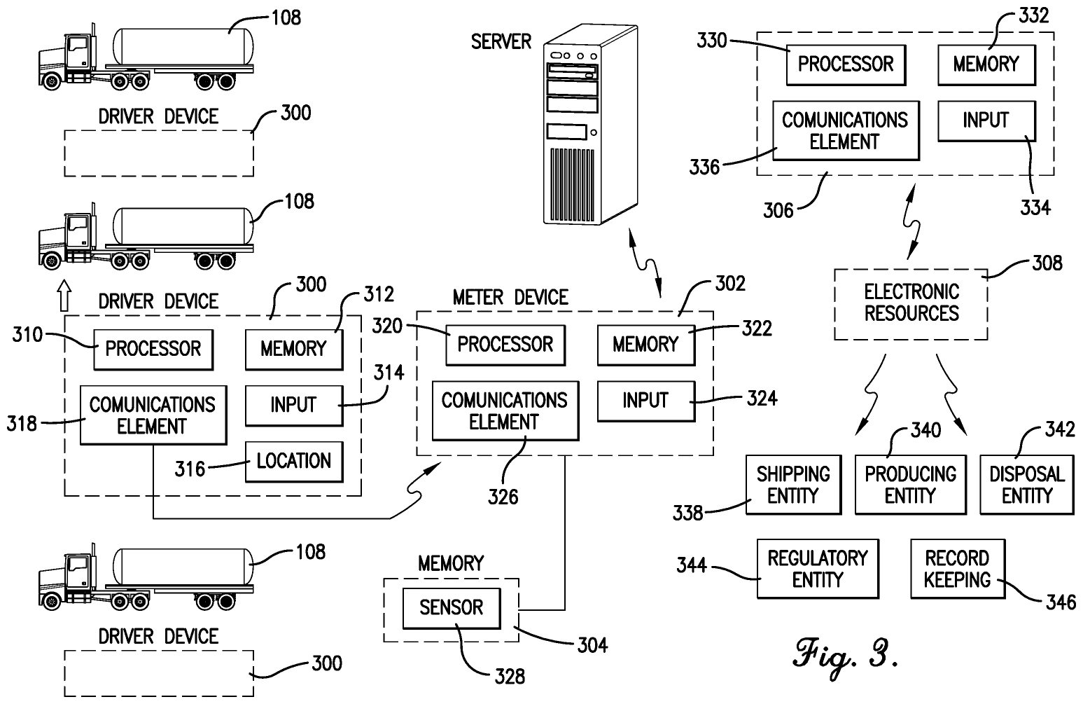

Turning to FIGS. 2-3, an exemplary embodiment of the wastewater metering system is shown. FIG. 2 shows the various sets of information which may be obtained regarding the wastewater disposal. FIG. 3 shows the various hardware components which may collect and analyze the information. The various hardware may utilize one or more methods, discussed below, in collecting and analyzing the information. The various hardware may also facilitate payments, keep records, streamline the pickup and drop off, and provide other practical applications.

Embodiments of the invention generate an electronic ticket indicative of the delivery of the wastewater pickup, delivery, and drop off. The generation of the electronic ticket is discussed below. The electronic ticket may include information from any of various sources associated with the wastewater pickup, delivery, and drop off. It should be appreciated that while the various information is separated into distinct data sets in FIG. 2, each of which is associated with a particular source, the information may be grouped or originated differently in embodiments of the invention. The layout of information in FIG. 2 is provided to give clarity to the reader.

In some embodiments, a production data set 200 is generated indicative of the production facility 100 and associated information. The production data set 200 provides information as to the source of the wastewater transported. As a first example, the production data set 200 may include a production facility name, or other identifying information for the production facility 100 (such as a number). As a second example, the production data set 200 may include a production facility location, or other identifying information as to the location of the production facility 100 (such as a city, county, state, or region). As a third example, the production data set 200 may include a production facility type, or other identifying information as to the type (such as the type machinery being used to produce the product, the specific type of machine(s) used to generate the wastewater, or the method of production). As a fourth example, the production data set 200 may include a production entity indicative of the business organization or other entity that runs the production or other identifying information (such as a number). As a fifth example, the production data set 200 may include a production agent name. The production agent is a person with which the transporter interacted during the pickup process, a person who oversaw the production of the wastewater, a contact person for the production facility 100, etc. As a sixth example, the production data set 200 may include a product type, such as oil, gasoline, natural gas, etc. As a seventh example, the production data set 200 may include wastewater information. The wastewater information may include information related to potential contaminants in the wastewater, levels of such contaminants, methods of disposal recommended or required, and other characteristics of the wastewater.

In some embodiments, a pickup data set 202 is generated indicative of the act of pickup and associated information. The pickup data set 202 provides information as to the pickup of the wastewater transported. As a first example, the pickup data set 202 may include a pickup time (such as a time in which the driver checked in, a time in which the pickup began, a time in which the pickup completed, etc.). As a second example, the pickup data set 202 may include a pickup tank, indicative of which wastewater tank 104 the pickup took place (for production facilities 100 with more than one wastewater tank 104). As a third example, the pickup data set 202 may include a pickup amount, indicative of how much wastewater was retrieved from the production facility 100. As a fourth example, the pickup data set 202 may include a pickup duration, indicative of how long the pickup process took. As a fifth example, the pickup data set 202 may include a pickup supervisor. The pickup supervisor is a person associated with the production facility 100 that oversaw the pickup process.

In some embodiments, a transportation data set 204 is generated indicative of the transportation of the wastewater from the pickup location to the drop off location (e.g., from the production facility 100 to the disposal facility 114). As a first example, the transportation data set 204 may include a vehicle identifier, such as a number. As a second example, the transportation data set 204 may include a vehicle make and model, providing additional information about the transportation vehicle 108. As a third example, the transportation data set 204 may include a vehicle entity. The vehicle entity is the business organization or other entity that controls the vehicle 108, the driver, and/or the transportation process. The vehicle entity may be referred to as a transportation entity. As a fourth example, the transportation data set 204 may include a driver name or other driver identifier (such as a number). As a fifth example, the transportation data set 204 may include a vehicle agent name. The vehicle agent may be a person distinct from the driver, such as a dispatcher or manager. The vehicle agent may be associated with the vehicle entity. As a sixth example, the transportation data set 204 may include a set of vehicle location information. The vehicle location information can provide an indication of the route the vehicle 108 took between the pickup location and the drop off location, the distance traveled, the travel time, etc.

In some embodiments, a drop off data set 206 is generated indicative of the act of drop off and associated information. The drop off is performed at the disposal facility 114. As a first example, the drop off data set 206 may include a drop off time (such as a time in which the vehicle 108 arrived at the drop off location, the time the drop off began, the time the drop off completed, and/or the time that the vehicle 108 left the drop off location). As a second example, the drop off data set 206 may include a drop off tank indicative of which wastewater receiving tank 112 the drop off was made (which may include a certain stall or station at which the drop off was made, such as a specific drop off apparatus 110). As a third example, the drop off data set 206 may include a drop off amount, such as measured by a meter (discussed below) at the drop off location or associated with the vehicle 108. As a fourth example, the drop off data set 206 may include a drop off duration indicative of how long the drop off took. As a fifth example, the drop off data set 206 may include a drop off supervisor. The drop off supervisor is a person associated with the disposal facility 114 that was present at or otherwise oversaw the drop off.

In some embodiments, a disposal data set 208 is generated indicative of the disposal facility 114 and associated information. As a first example, the disposal data set 206 may include a disposal facility name. As a second example, the disposal data set 206 may include a disposal facility location. As a third example, the disposal data set 206 may include a disposal facility type. As a fourth example, the disposal data set 206 may include a disposal entity. The disposal entity is the business organization or other entity associated with the disposal location. As a fifth example, the disposal data set 206 may include a disposal agent name. The disposal agent is a person associated with the disposal location, such as a supervisor or owner.

These data sets may be collected and/or processed by one or more electronic devices, as shown in FIG. 3. The electronic devices may include a driver device 300, a meter device 302 associated with a meter 304, a server 306, and an electronic resource 308. Before discussing the electronic device individually, various generic aspects of the computing devices will be discussed, which may apply to any or all of the computing devices. The computing devices may comprise any number and combination of processors, controllers, integrated circuits, programmable logic devices, or other data and signal processing devices for carrying out the functions described herein, and may additionally comprise one or more memory storage devices, transmitters, receivers, displays, and/or communication busses for communicating with the various devices of the system.

Any of the computing devices can be a desktop computer, a laptop computer, a server 306 computer, a mobile device such as a smartphone or tablet, or any other form factor of general- or special-purpose computing device. The computing devices will be described with certain components that may be arranged differently or absent. Additional components may also be present. Included in the computing device is system bus, whereby other components of the computing device can communicate with each other. In certain embodiments, there may be multiple busses or components may communicate with each other directly. Connected to the system bus is central processing unit (CPU). Also attached to the system bus are one or more random-access memory (RAM) modules.

Also attached to the system bus is a graphics card. In some embodiments, the graphics card may not be a physically separate card, but rather may be integrated into the motherboard or the CPU. In some embodiments, graphics card has a separate graphics-processing unit (GPU), which can be used for graphics processing or for general purpose computing (GPGPU). Also on the graphics card may be a GPU memory. Connected (directly or indirectly) to the graphics card is a display for user interaction. In some embodiments no display is present, while in others it is integrated into the computing device. Similarly, peripherals such as a keyboard and a mouse are connected to system bus. Like the display, these peripherals may be integrated into the computing device or absent. Also connected to the system bus is a local storage, which may be any form of computer-readable media, and may be internally installed in the computing device or externally and removably attached.

A network interface card (NIC) may also be attached to the system bus and allows the computing device to communicate over a network. The NIC can be any form of network interface known in the art, such as Ethernet, ATM, fiber, Bluetooth, or Wi-Fi (i.e., the IEEE 802.11 family of standards). The NIC connects the computing device to a local network, which may also include one or more other computers and/or network storage. The local network is in turn connected to the Internet, which connects many networks, remote networks, or directly attached computers. In some embodiments, the computing device can itself be directly connected to the Internet.

The server devices and computing devices may include any device, component, or equipment with a processing element and associated memory elements. The processing element may implement operating systems, and may be capable of executing the computer program, which is also generally known as instructions, commands, software code, executables, applications (“apps”), and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), and the like, or combinations thereof. In addition to these memory elements, the server 306 devices may further include file stores comprising a plurality of hard disk drives, network attached storage, or a separate storage network.

The computing devices may specifically include mobile communication devices (including wireless devices), work stations, desktop computers, laptop computers, palmtop computers, tablet computers, portable digital assistants (PDA), smart phones, smart watches, and the like, or combinations thereof. Various embodiments of the computing device may also include voice communication devices, such as cell phones and/or smart phones. In some embodiments, the computing device will have an electronic display operable to display visual graphics, images, text, etc. In certain embodiments, the computer program facilitates interaction and communication through a GUI that is displayed via the electronic display. The GUI enables the user to interact with the electronic display by touching or pointing at display areas to provide information to the system.

The communications network may be wired or wireless and may include servers, routers, switches, wireless receivers and transmitters, and the like, as well as electrically conductive cables or optical cables. The communications network may also include local, metro, or wide area networks, as well as the Internet, or other cloud networks. Furthermore, the communications network may include cellular or mobile phone networks, as well as landline phone networks, public switched telephone networks, fiber optic networks, or the like.

The processing element may include one or more processors, microprocessors, microcontrollers, digital signal processors (DSPs), field-programmable gate arrays (FPGAs), analog and/or digital application-specific integrated circuits (ASICs), or the like, or combinations thereof. The processing element may generally execute, process, or run instructions, code, code segments, software, firmware, programs, applications, apps, processes, services, daemons, or the like, or may step through states of a finite-state machine, or combinations of these actions. Machine learning techniques may also be implemented by the processing element. The processing element may be in communication with the other electronic components through serial or parallel links that include address busses, data busses, control lines, and the like.

The processing element may be configured to retrieve, process and/or analyze data stored in memory device, to store data in the memory device, to replace data stored in the memory device, to analyze data or signals, capture video and/or image data, generate data, receive commands, control various functions of the systems, etc. In some configurations, the processing element may consist of a single microprocessor or microcontroller. However, in other configurations, the processing element may comprise a plurality of processing devices (e.g., microprocessors, DSPs, etc.), such that each processor is configured to control and perform different operational functions.

The memory device may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The memory device may include, or may constitute, a “non-transitory computer-readable storage medium.” The memory device may store the instructions, code, code segments, software, firmware, programs, applications, apps, services, daemons, or the like that are executed by the processing element. The memory device may also store settings, data, documents, sound files, photographs, movies, images, databases, and the like.

Inputs may include buttons, pushbuttons, knobs, jog dials, shuttle dials, directional pads, multidirectional buttons, switches, keypads, keyboards, mice, joysticks, microphones, touchscreens, or the like, or combinations thereof. Outputs may include lights, dials, meters, or the like, or combinations thereof.

The communications element generally enables communication between and among the respective electronic device and external systems or devices. The communications element may include signal or data transmitting and receiving circuits, such as amplifiers, filters, mixers, oscillators, digital signal processors (DSPs), and the like. Various combinations of these circuits may form a transceiver, which transmits, receives, and processes signals such as the ones listed in the following discussion. The communications element may establish communication wirelessly by utilizing radio frequency (RF) signals and/or data that comply with communication standards such as cellular 2G, 3G, or 4G, Institute of Electrical and Electronics Engineers (IEEE) 802.11 standard such as Wi-Fi, IEEE 802.16 standard such as WiMAX, Bluetooth™, or combinations thereof. In addition, the communications element 362 may utilize communication standards such as ANT, ANT+, Bluetooth™ low energy (BLE), the industrial, scientific, and medical (ISM) band at 2.4 gigahertz (GHz), or the like. The communications element may be in communication with the processing element and the memory device. In various embodiments, the electronic device may be configured to establish communication with more than one protocol or standard, and the communications element may include a transceiver for each protocol or standard, such as Bluetooth™, Wi-Fi, cellular, etc., with which the electronic can communicate. The communications element may be in electronic communication with an antenna that wirelessly transmits and receives electronic signals to and from other electronic devices, such as a smartphone, a tablet, a laptop, or a desktop computer, or communication network interfaces such as a Wi-Fi router or a cell tower.

The specific components shown in FIG. 3 will now be discussed in more detail. Generally, FIG. 3 shows the driver device 300 each associated with the vehicle 108, the meter device 302 associated with the meter 304, and a remote server 306 configured to receive information from at least one of the meter device 302 and the driver device 300. The communication between the server 306 and the meter device 302 and/or the driver device 300 may be over any of the above-discussed networks.

The driver device 300 comprises a processor 310, a memory 312, an input 314, a location element 316, and a communications element 318. The processor 310 may be any of the above-discussed types of processing elements. The memory 312 may be any of the above-discussed types of memory elements. The communications element 318 may be any of the above-discussed types of communications elements.

The location element 316 is configured to determine a current geographic location of the driver device 300. The location element 316 may be any of various types of position-determining devices and/or systems. For example, the location element 316 may be a global positioning system (GPS) receiver. As another example, the location element 316 may be a mobile broadband receiver configured to determine location based upon mobile broadband signals. The location element 316 reports the current location to the processor 310 such that the processor 310 may track the location of the driver device 300, so as to allow for a record of delivery times and locations.

In some embodiments, the driver device 300 is a computing device secured within the transportation vehicle 108. In these embodiments, the driver device 300 may be mounted within a cab of the transportation vehicle 108. The driver device 300 may have a wired connection to any of various devices within the vehicle 108, such as a vehicle meter and/or an OBD-2 device. In other embodiments, the driver device 300 is an independent computing device, such as a smart phone, utilized by the driver.

The input 314 may be any of the above-discussed types of inputs. Specifically, the input 314 may include a scanner configured to scan an indication at the pickup location, such as a QR code or bar code indicative of at least a portion of the production data set 200. As another example, the input 314 may include a keyboard (such as a physical keyboard or a keyboard displayed upon a touch screen) such that the user may manually enter information related to the production data set 200 and the pickup data set 202. In other embodiments, the location element may act as an input upon the location element determining that the driver device 300 is within a certain radius of a production facility 100.

Thus, the processing element may store, in the memory element, an input from the user via the input device. The processing element may also store, in the memory element, said current geographic location. The processing element may then relay this information to the meter device 302 and/or the server 306 device. The information gathered by the driver device 300 may include at least a portion of the production data set 200, at least a portion of the pickup data set 202, a least a portion of the delivery data set, at least a portion of the drop off data set 206, and/or at least a portion of the disposal data set 206.

The meter device 302 comprises a processor 320, a memory 322, an input 324, and a communications element 326. The processor 320 may be any of the above-discussed types of processing elements. The memory 322 may be any of the above-discussed types of memory elements. The input 324 may be any of the above-discussed types of inputs. The communications element 326 may be any of the above-discussed types of communications elements. The information gathered by the meter device 302 may include at least a portion of the production data set 200, at least a portion of the pickup data set 202, a least a portion of the delivery data set, at least a portion of the drop off data set 206, and/or at least a portion of the disposal data set 206.

The meter 304 includes a sensor 328. The sensor measures the amount of wastewater deposited into the wastewater receiving tank 112 by the vehicle 108. The meter 304 and/or meter device 302 may also measure and/or calculate other data points, such as mass flow rate, volume flow rate, density, temperature, etc. Examples of the sensor 328 includes the magnetic meter sensors and Coriolis meter sensors. Thus, based upon the corresponding sensor, the meter 304 may be a magnetic meter or a Coriolis meter. A magnetic meter, also known as a magnetic flow meter, is a transducer that measures flu id flow by the voltage induced across the liquid by its flow through a magnetic field. This measures the fluid flow via electromagnetic induction. A Coriolis meter, also known as a Coriolis flow meter or (more generically) a mass flow meter or inertial flow meter, is a device that measures mass flow through the meter 304. Coriolis meters include curved tube and straight tube varieties. The flow induces a slight twist in the curved tube, and the meter measures such twist to determine a flow rate. Examples of magnetic flow meters and Coriolis flow meters are produced by EMERSON.

The server 306 includes a processor 330, a memory 332, an input 334, and a communications element 336. The processor 330 may be any of the above-discussed types of processing elements. The memory 332 may be any of the above-discussed types of memory elements. The input 334 may be any of the above-discussed types of inputs. The communications element 318 may be any of the above-discussed types of communications elements.

The server 306 of embodiments of the invention is configured to acquire the set of driver information and the set of meter information. The server 306 may acquire the set of driver information from the driver device 300 directly, or indirectly through the meter device 302. The server 306 device is also configured to generate an electronic ticket based at least in part of the set of driver information and the set of meter information, as discussed below. The server 306 is also configured to provide the electronic ticket (or a summary thereof) via an electronic resource 308.

In some embodiments, the electronic resource 308 is a website, database, data store, cloud-based storage, or the like. Typically, the electronic resource 308 is remotely accessible such that any of the various involved entities may access the electronic resource 308 as needed. The electronic resource 308 is communicatively coupled to and/or accessible by any of various external computer systems. A shipping entity system 338, a producing entity system 340, a disposal entity system 342, a regulatory entity system 344, and/or a record keeping system 346 may each access the electronic resource 308 to retrieve information.

Some embodiments of the invention are directed to a computerized method of metering wastewater. Other embodiments of the invention are directed to a meter device 302 including an electronic control unit configured to control the operations of the meter device 302. Still other embodiments of the invention may be directed to a non-transitory computer readable storage medium having a computer program stored thereon, wherein the computer program instructs the various processing elements to perform the discussed steps.

### Exemplary Methods

While various methods of using the embodiments of the invention have been discussed throughout, a method of generating and utilizing an electronic ticket will now be discussed. The method may be a computerized method configured to be performed by a processing element of one of the devices discussed herein (or other similar device). The method may be instructed based upon execution of a computer program stored upon a non-transitory computer readable storage medium.

The computer program of embodiments of the invention comprises a plurality of code segments executable by a computing device for performing the steps of various methods of the invention. The steps of the method may be performed in the order discussed, or they may be performed in a different order, unless otherwise expressly stated. Furthermore, some steps may be performed concurrently as opposed to sequentially. Also, some steps may be optional. The computer program may also execute additional steps not described herein. The computer program, system, and method of embodiments of the invention may be implemented in hardware, software, firmware, or combinations thereof, which broadly comprises server 306 devices, computing devices, and a communications network.

The computer program of embodiments of the invention may be responsive to user input. As defined herein user input may be received from a variety of computing devices including but not limited to the following: desktops, laptops, calculators, telephones, smartphones, smart watches, in-car computers, camera systems, or tablets. The computing devices may receive user input from a variety of sources including but not limited to the following: keyboards, keypads, mice, trackpads, trackballs, pen-input devices, printers, scanners, facsimile, touchscreens, network transmissions, verbal/vocal commands, gestures, button presses or the like

The computer program may run on computing devices or, alternatively, may run on one or more server 306 devices. In certain embodiments of the invention, the computer program may be embodied in a stand-alone computer program (i.e., an “app”) downloaded on a user's computing device or in a web-accessible program that is accessible by the user's computing device via the communications network. As used herein, the stand-along computer program or web-accessible program provides users with access to an electronic resource from which the users can interact with various embodiments of the invention.

Execution of the computer program of embodiments of the invention performs steps of the method of embodiments of the invention. Because multiple users may be updating information stored, displayed, and acted upon by the computer program, information displayed by the computer program is displayed in real-time. “Real-time” as defined herein is when the processing element of the system performs the steps less than every 1 second, every 500 milliseconds, every 100 milliseconds, or every 16 milliseconds.

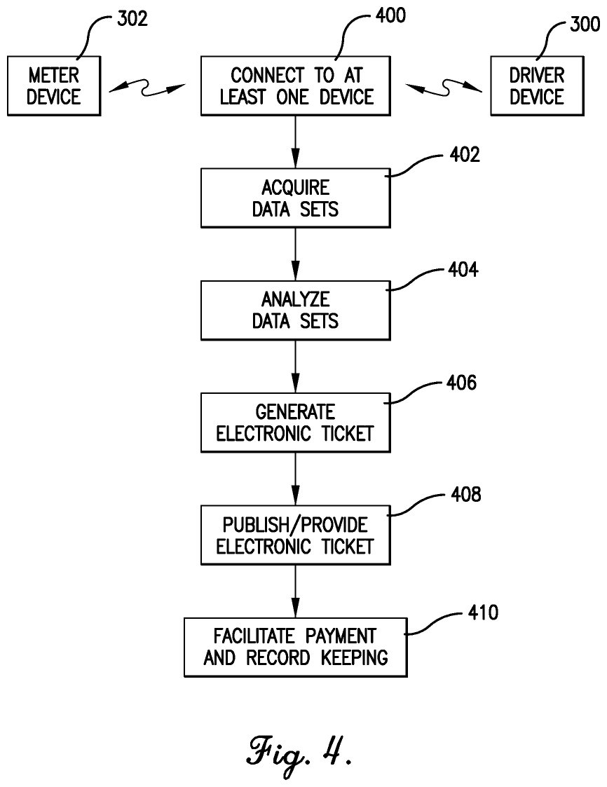

The steps performed at least in part by the processor 330 (or another generic processing element) of the server 306 are shown in FIG. 4 and will now be discussed. Broadly, the server 306 gathers information related to the transportation of the wastewater, analyzes the information, prepares an electronic ticket, and performs other follow on functions that assist in collecting and/or record keeping functions.

In Step 400, the processing element connects to at least one device, such as the driver device 300 and/or the meter device 302. In some embodiments, the processing element is communicatively coupled to at least one of a meter device 302 and a driver device 300. In some embodiments, the driver device 300 provides information, directly or indirectly, to the meter device 302. In these embodiments, the meter device 302 may provide all (or substantially all) information to the server 306. This simplifies the connection process, such that the server 306 only needs to connect to the static, and typically less numerous, meter devices 302. The connection may be over any of the discussed wireless or wired connection protocols.

In Step 402, the processing element acquires data sets from the meter device 302 and/or the driver device 300. The processing element may acquire this information at the conclusion of each disposal process, at a certain interval (such as once per hour or once per day), or upon specific request of the server 306. The information may thus be pushed by the device or pulled by the server 306. The processing element may receive the sets of data with appropriate metadata and in a certain format to aid in the later analysis of the sets of data.

In some embodiments, the processing element acquires a set of meter information associated with a disposal location for wastewater, and acquires a set of driver information associated with a transportation vehicle 108 for wastewater. The sets of information may be based upon the origin of the information (e.g., from the driver device 300 and/or the meter device 302). The sets of information may also include the above-discussed production data set 200, the pickup data set 202, the transportation data set 204, the drop off data set 206, and/or the disposal data set 206.

In Step 404, the processing element analyzes the data sets. The processing element may pull information from one or more data sets and perform any of various analysis, calculations, extrapolations, interpolations, or the like. For example, the drop off data set 206 may include a drop off amount, which the processing element may multiply by an appropriate cost rate for the wastewater. The product of the calculation may be at least partially indicative of the amount due by the production entity to the vehicle 108 entity for the provided service. Other exemplary analysis may include determining a length of time for the delivery, a distance covered in the delivery, a time of day for the delivery (e.g., during or outside regular business hours), a total number/amount for a given driver or production facility 100, and the like.

In some embodiments, the step of analyzing the set of driver information and the set of meter information includes identifying a vehicle 108 entity and a production entity. The vehicle 108 entity, as discussed above, is the entity responsible for, or otherwise associated with, the delivery of the wastewater. The vehicle 108 entity typically expects payment from the production entity for the service of disposing of the wastewater.

In Step 406, the processing element generates the electronic ticket. The electronic ticket is an electronic record of the delivery of the wastewater. The electronic ticket includes information from the data sets as well as the results of any calculations, or the like. The electronic ticket is generated based at least in part of the set of driver information and the set of meter information. The electronic ticket may include any of numerous security features to ensure the veracity of the electronic ticket. The electronic ticket may be customized to include the information relevant to a certain party.

In Step 408, the processing element publishes or otherwise provides the electronic ticket. The electronic ticket may be sent to the respective parties individually or collectively. The electronic ticket may be published on an electronic resource 308, such as a website. Users, from the respective parties, may provide credentials to gain access to their electronic tickets and/or summaries thereof. Thus, the electronic ticket is provided to both the vehicle 108 entity and the production entity. The vehicle 108 entity expects payment based upon the delivered wastewater, and the production entity expects accurate and reliable accounting of the wastewater delivered. In some embodiments, the disposal entity may also expect payment for processing or otherwise disposing of the wastewater. The payment may come from the vehicle 108 entity and/or the production entity, depending upon the arrangement between the parties. Some embodiments of the invention are controlled, directly or indirectly, by the disposal facility 114. In these embodiments, the electronic ticket is, in essence, provided to the vehicle 108 entity and the production entity by the disposal entity.

In Step 410, the processing element may provide further functions, such as facilitating payments and record keeping. In some embodiments, the processing element facilitates payment between the production entity and the vehicle 108 entity, based at least in part on the electronic ticket. The processing element may also facilitate payment between the various parties and the disposal entity. The processing element may also facilitate, via the electronic resource 308, record keeping of a set of electronic tickets including said electronic ticket. The record keeping may simplify accounting and payments. The record keeping may also assist in other business aspects, such as vehicle 108 and other equipment maintenance. For example, the production facility 100 may track the amount of wastewater produced by the facility to test efficiencies.

In some embodiments of the invention, the processing element sends the electronic ticket to a headquarters location for the production facility 100, the vehicle 108 entity, and/or to a government administrative office. The various entities may finalize and double-check the electronic ticket before sending it on to other entities. The electronic ticket may be delivered to the entity electronically and allow for the customer to electronically approve, pay, record, or perform other functions in relation to the electronic ticket. In some embodiments, the entity may be presented with multiple electronic tickets via a computer program on a device or a website. Similarly, the electronic ticket (or a related summary document) may be electronically delivered to the government administrative entity for approval and/or record keeping.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claim(s) set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in the paragraph shall apply unless so stated in this description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

We claim:

1. A wastewater metering system comprising:
a driver device associated with a disposal vehicle,
wherein the driver device is configured to acquire a set of driver information;
a meter device associated with a disposal location,
wherein the meter device is configured to acquire a set of meter information; and
a server communicatively coupled with at least one of the driver device and the meter device,
said server including a processor configured to:
acquire the set of driver information and the set of meter information;
generate an electronic ticket based at least in part of the set of driver information and the set of meter information; and
provide the electronic ticket via an electronic resource.

2. The wastewater metering system of claim 1, wherein the driver device is a computing device secured within the disposal vehicle.

3. The wastewater metering system of claim 2, wherein the driver device includes:
an input device
a location element configured to determine a current geographic location of the driver device;
a memory element; and
a processing element configured to:
store, in the memory element, an input from the user via the input device
store, in the memory element, said current geographic location.

4. The wastewater metering system of claim 1,
wherein the metering device is associated with a meter at the disposal location,
wherein the meter is configured to measure wastewater being delivered to the disposal location,
wherein the meter device is configured to acquire at least a portion of the set of meter information from the meter.

5. The wastewater metering system of claim 4, wherein the meter is selected from the group consisting of magnetic meters and Coriolis meters.

6. The wastewater metering system of claim 1, wherein the metering device is configured to acquire the set of driver information from the driver device.

7. The wastewater metering system of claim 6, wherein the server device is configured to receive both the set of driver information and the set of driver information from the meter device.

8. The wastewater metering system of claim 1, wherein the processor of the server is further configured to:
facilitate record keeping of a set of electronic tickets; and
facilitate payment between at least two entities based at least in part on the electronic ticket.

9. A computerized method of metering wastewater comprising:
acquiring a set of meter information associated with a disposal location for wastewater;
acquiring a set of driver information associated with a disposal vehicle for wastewater;
analyzing the set of driver information and the set of meter information;
generating an electronic ticket based at least in part of the set of driver information and the set of meter information; and
providing the electronic ticket via an electronic resource.

10. The computerized method of claim 9, further comprising:
communicatively connecting to at least one of a meter device and a driver device; and
requesting at least one of the set of meter information and the set of driver information.

11. The computerized method of claim 9, wherein the step of analyzing the set of driver information and the set of meter information includes:
identifying a vehicle entity; and
identifying a production entity.

12. The computerized method of claim 11, wherein the electronic ticket is provided to both the vehicle entity and the production entity.

13. The computerized method of claim 12, further comprising:
facilitating payment between the production entity and the vehicle entity, based at least in part on the electronic ticket.

14. The computerized method of claim 9, further comprising:
facilitating, via the electronic resource, record keeping of a set of electronic tickets including said electronic ticket.

15. A non-transitory computer readable storage medium having a computer program stored thereon, wherein the computer program, when executed by at least one processing elements, instructs the at least one processing element to perform steps comprising:
acquiring a set of meter information associated with a disposal location for wastewater;
acquiring a set of driver information associated with a disposal vehicle for wastewater;
analyzing the set of driver information and the set of meter information;
generating an electronic ticket based at least in part of the set of driver information and the set of meter information; and
providing the electronic ticket via an electronic resource.

16. The non-transitory computer readable storage medium of claim 15, further comprising:
communicatively connecting to at least one of a meter device and a driver device; and
requesting at least one of the set of meter information and the set of driver information.

17. The non-transitory computer readable storage medium of claim 15, wherein the step of analyzing the set of driver information and the set of meter information includes:
identifying a vehicle entity; and
identifying a production entity.

18. The non-transitory computer readable storage medium of claim 17, wherein the electronic ticket is provided to both the vehicle entity and the production entity.

19. The non-transitory computer readable storage medium of claim 18, further comprising:
facilitating payment between the production entity and the vehicle entity, based at least in part on the electronic ticket.

20. The non-transitory computer readable storage medium of claim 15, further comprising:
facilitating, via the electronic resource, record keeping of a set of electronic tickets including said electronic ticket.
